(19) United States
(12) Patent Application Publication
(10) Pub. No.: US 2014/0198282 A1
(43) Pub. Date: Jul. 17, 2014

(54) POLARIZER AND LIQUID CRYSTAL DISPLAY INCLUDING THE SAME

(71) Applicant: Samsung Display Co., Ltd., Yongin-city (KR)

(72) Inventors: Min Oh CHOI, Cheonan-si (KR); Hee Wook DO, Cheonan-si (KR); Boo-Kan KI, Yongin-si (KR); Kyeong Ha KIM, Yongin-si (KR); Teck Soo KIM, Seongnam-si (KR); Sang-Gu LEE, Hwaseong-si (KR)

(73) Assignee: Samsung Display Co., Ltd., Yongin-city (KR)

(21) Appl. No.: 14/105,845

(22) Filed: Dec. 13, 2013

(30) Foreign Application Priority Data
Jan. 13, 2013 (KR) 10-2013-0004998

(51) Int. Cl. G02F 1/1335; G02B 5/30

(52) U.S. Cl. CPC G02F 1/133528; G02B 5/305; G02B 5/3016
USPC 349/96; 359/483.01; 359/488.01

(57) ABSTRACT

A polarizer includes a polyvinyl alcohol (PVA) layer, a supporting layer, and a compensation layer. The supporting layer is disposed on the PVA layer. The supporting layer includes a cyclic olefin polymer (COP). The compensation layer is disposed on the supporting layer. The compensation layer includes discotic liquid crystal. The refractive index of the supporting layer is between 1.49 and 1.55. The refractive index of the compensation layer is between 1.50 and 1.60.

### CROSS-REFERENCE TO RELATED APPLICATION

This application claims priority from and the benefit of Korean Patent Application No. 10-2013-0004998, filed on Jan. 16, 2013, which is incorporated by reference for all purposes as if set forth herein.

### BACKGROUND

1. Field

Exemplary embodiments relate to display technology, and more particularly to, polarizers and liquid crystal displays including the same.

2. Discussion

Liquid crystal displays (LCD) are one of the most widely used flat panel displays. An LCD typically includes two panels provided with field-generating electrodes, such as pixel is electrodes and a common electrode, and a liquid crystal (LC) layer disposed therebetween. The LCD displays images by applying voltage(s) to the field-generating electrodes to generate an electric field in the LC layer, which orients LC molecules in the LC layer, as well as adjusts polarization of incident light.

Conventional liquid crystal displays are typically classified into three categories, e.g., transmissive liquid crystal displays, reflective liquid crystal displays, and transflective liquid crystal displays. A transmissive liquid crystal display displays an image using an internal light source, such as a backlight disposed at a rear side of a liquid crystal cell. A reflective liquid crystal display displays an image using external light, such as natural (or otherwise ambient) light. A transflective liquid crystal display combines a transmissive liquid crystal display and a reflective liquid crystal display, such that the transflective liquid crystal display includes a reflective area and a transmissive area.

It is noted that liquid crystal displays typically also include a plurality of polarizers, such that the liquid crystal layer is disposed between a first one of the plurality of polarizers and a second one of the plurality of polarizers. Each of the plurality of polarizers is configured to transmit incident light of a determined polarization direction. As such, transmittance of conventional liquid crystal displays is low (e.g., at 50% transmission). This decreases display luminance, and thereby, display quality.

The above information disclosed in this Background section is only for enhancement of understanding of the background of the invention, and therefore, it may contain information that does not form the prior art that is already known in this country to a person of ordinary skill in the art.

### SUMMARY

Exemplary embodiments provide a polarizer configured to transmit at least a determined degree of incident, non-polarized light, and thereby, configured to improve display quality.

Exemplary embodiments provide a liquid crystal display including a polarizer configured to transmit at least a determined degree of incident, non-polarized light, and thereby, configured to improve display quality.

According to exemplary embodiments, a polarizer, includes: a polyvinyl alcohol (PVA) layer; a supporting layer disposed on the PVA layer, the supporting layer including a cyclic olefin polymer (COP); and a compensation layer disposed on the supporting layer, the compensation layer including discotic liquid crystal. The refractive index of the supporting layer is between 1.49 and 1.55. The refractive index of the compensation layer is between 1.50 and 1.60.

According to exemplary embodiments, a polarizer, includes: a polyvinyl alcohol (PVA) layer; a supporting layer disposed on the PVA layer, the supporting layer including a cyclic olefin polymer (COP); and a compensation layer disposed on the supporting layer, the compensation layer including discotic liquid crystal. The refractive index of the compensation layer is 1.5, between 1.52 and 1.54, 1.56, or between 1.58 and 1.6. When the refractive index of the compensation layer is 1.5, the refractive index of the supporting layer is between 1.45 and 1.55. When the refractive index of the compensation layer is between 1.52 and 1.54, the refractive index of the supporting layer is between 1.49 and 1.53. When the refractive index of the compensation layer is 1.56, the refractive index of the supporting layer is between 1.49 and 1.55. When the refractive index of the compensation layer is between 1.58 and 1.6, the is refractive index of the supporting layer is between 1.53 and 1.55.

According to exemplary embodiments, a liquid crystal display, includes: a first substrate; a second substrate facing the first substrate; a liquid crystal layer disposed between the first substrate and the second substrate; a first polarizer disposed on the first insulation substrate; and a second polarizer disposed on the second substrate. The first substrate and the second substrate are disposed between the first polarizer and the second polarizer. At least one of the first polarizer and the second polarizer includes: a polyvinyl alcohol (PVA) layer; a supporting layer disposed on the PVA layer, the supporting layer including a cyclic olefin polymer (COP); and a compensation layer disposed on the supporting layer, the compensation layer including discotic liquid crystal. The refractive index of the supporting layer is between 1.49 and 1.55. The refractive index of the compensation layer is between 1.50 and 1.60.

According to exemplary embodiments, the supporting member including the COP does not include a TAC, such that the transmittance of the polarizer is improved, as well as display quality of a display device including the same.

The foregoing general description and the following detailed description are exemplary and explanatory and are intended to provide further explanation of the invention as claimed.

### BRIEF DESCRIPTION OF THE DRAWINGS

FIG. 1 is a cross-sectional view of a liquid crystal display, according to exemplary embodiments.

FIG. 2 is a cross-sectional view of a polarizer, according to exemplary embodiments.

FIGS. 3-6 illustrate tabular or graphic characteristics of a cyclic olefin polymer (COP) used in a polarizer, according to exemplary embodiments.

FIGS. 7-9 compare refractive indices of a polarizer with transmission characteristics thereof, according to exemplary embodiments.

FIG. 10 is a cross-sectional view of a polarizer, according to exemplary embodiments.

FIGS. 11-13 compare display characteristics of a display device with characteristics of a polyvinyl alcohol (PVA) polarizer layer in the display device, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or directly coupled to the other element or layer or intervening elements or layers may be present. When, however, an element or layer is referred to as being “directly on,” “directly connected to,” or “directly coupled to” is another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” and/or the like, may be used herein for descriptive purposes and, thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations) and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, is should be interpreted as having a meaning that is consistent with their meaning in the context of the relevant art and will not be interpreted in an idealized or overly formal sense, unless expressly so defined herein.

While exemplary embodiments are described in association with a liquid crystal display device, it is contemplated that exemplary embodiments may be utilized in association with other or equivalent display devices, such as various self-emissive and/or non-self-emissive display technologies. For instance, self-emissive display devices may include organic light emitting displays (OLED), plasma display panels (PDP), etc., whereas non-self-emissive display devices may constitute liquid crystal displays (LCD), electrophoretic displays (EPD), electrowetting displays (EWD), and/or the like.

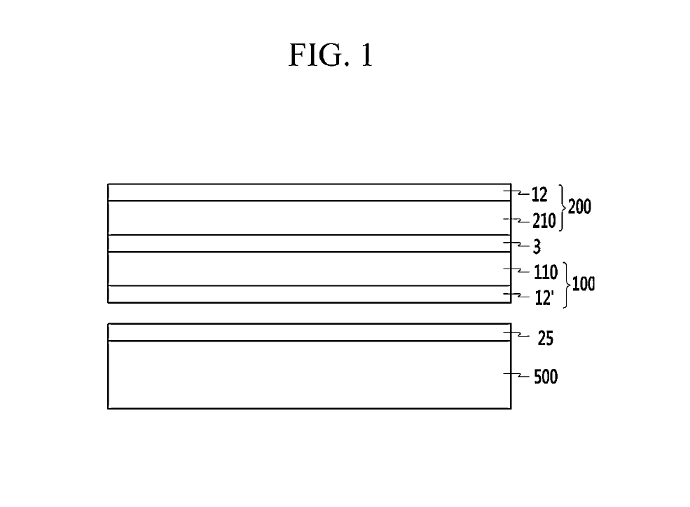

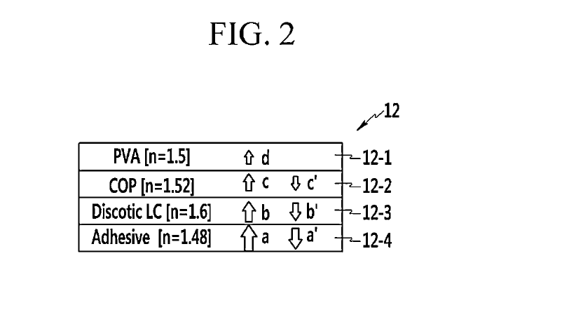

FIG. 1 is a cross-sectional view of a liquid crystal display, according to exemplary embodiments. FIG. 2 is a cross-sectional view of a polarizer, according to exemplary embodiments.

A liquid crystal display, according to exemplary embodiments, includes backlight unit 500, optical sheet 25, a first (e.g., lower) panel 100, a liquid crystal layer 3, and a second (e.g., upper) panel 200. While specific reference will be made to this particular implementation, it is also contemplated that the liquid crystal display may embody many forms and include multiple and/or alternative components. For example, it is contemplated that the components of the liquid crystal display may be combined, located in separate structures, and/or separate locations.

While not illustrated, backlight unit 500 includes a light source, a light guide plate, and a reflector. The optical sheet 25 is disposed on the backlight unit 500.

The configuration of backlight unit 500 enables light supplied from the light is source to pass through the light guide plate and the reflector, and thereby, to be discharged from the backlight unit 500 pass through the optical sheet 25 disposed on the backlight unit 500. In this manner, the light may propagate through lower panel 100, liquid crystal layer 3, and upper panel 200.

According to exemplary embodiments, the light source may be (or include), for example, a fluorescent lamp (such as a cold-cathode fluorescent lamp (CCFL)), a light emitting diode (LED), and/or the like. The light source may be disposed on a side or a lower surface of the backlight unit 500.

The optical sheet 25 may include at least one optical sheet, and may include a prism sheet including a prism structure or a diffusion film, such as a diffuser. In exemplary embodiments, the optical sheet 25 may include a luminance improvement film, in which layers of different refractive indices are repeatedly formed. It is contemplated, however, that the optical sheet 25 may be formed in any other suitable manner.

As seen in FIG. 1, lower panel 100, liquid crystal layer 3, and upper panel 200 may be disposed on the backlight unit 500 and the optical sheet 25.

According to exemplary embodiments, lower panel 100, liquid crystal layer 3, and upper panel 200 display a gray image by transmitting light of a determined polarization direction that is received from lower polarizer 12′. It is noted that a polarization characteristic of the received light may be affected in the liquid crystal layer 3, such that light radiating from liquid crystal layer 3 may be transmitted or blocked by upper polarizer 12.

The lower panel 100 will now be described in more detail.

According to exemplary embodiments, lower panel 100 may include a lower polarizer 12′ and a lower insulation substrate 110. The lower polarizer 12′ is disposed between is the lower insulation substrate 110 and the optical sheet 25. To this end, the lower insulation substrate 110 may be made of (or include) any suitable material, such as, for example, transparent glass, plastic, etc.

The lower polarizer 12′ may be an absorptive polarizer. The structure of the lower polarizer is described in more detail in association with FIG. 2.

As seen in FIG. 2, the lower polarizer 12′ may include a polyvinyl alcohol (PVA) layer 12-1, a supporting layer 12-2, a compensation layer 12-3, and an adhesive 12-4. While specific reference will be made to this particular implementation, it is also contemplated that the lower polarizer 12′ may embody many forms and include multiple and/or alternative components.

According to exemplary embodiments, the adhesive 12-4 couples the lower polarizer 12′ to a first (e.g., lower) surface of the lower insulation substrate 110. Any suitable material may be used as the adhesive 12-4, such that the adhesive 12-4 forms an optically clear adhesive film, a pressure sensitive adhesive (PSA), etc. In exemplary embodiments, the refractive index of the adhesive 12-4 is 1.48.

As seen in FIG. 1, the lower polarizer 12′ is coupled to a bottom surface of the lower insulation substrate 110, but in FIG. 2, the lower polarizer 12′ is illustrated with adhesive 12-4 being disposed at a lower surface of the lower polarizer 12′. As such, when coupled to the bottom surface of the lower insulation substrate 110, the lower polarizer 12′ includes a structure in which the layers 12-1, 12-2, 12-3, and 12-4 are in a reversed order.

With continued reference to FIG. 2, the compensation layer 12-3 is disposed on the adhesive 12-4. The compensation layer 12-3 includes discotic liquid crystal. According to exemplary embodiments, the refractive index of the compensation layer is 1.6. The is compensation layer 12-3 may include a film that is rubbed to arrange the discotic liquid crystal. That is, the discotic liquid crystal may be disposed on the rubbed film, such that discotic liquid crystal molecules thereof are arranged in the rubbing direction near the rubbed film, and arranged in a different direction further away from the rubbed film. In this manner, the discotic liquid crystal may include a hybrid arrangement. Further, the discotic liquid crystal may be hardened to prevent the refractive index of the compensation layer 12-3 from changing. As such, the discotic liquid crystal may be disposed on the rubbed film in a hardened, hybrid-aligned state.

According to exemplary embodiments, the supporting layer 12-2 is disposed on the compensation layer 12-3. The supporting layer 12-2 includes a cyclic olefin polymer (COP). The COP is formed through a stretching process, such that the refractive index of the supporting layer 12-2 may be controlled by the stretching process in an x-axis direction or a y-axis direction. The refractive index of the supporting layer 12-2, according to exemplary embodiments, may be 1.52. To this end, it is noted that the supporting layer 12-2 may not include triacetate cellulose (TAC).

As seen in FIG. 2, the PVA layer 12-1 is disposed on the supporting layer 12-2. The PVA layer 12-1 is configured to transmit incident light in one linearly polarized direction. The refractive index of the PVA layer 12-1, according to exemplary embodiments, may be 1.5.

An outer surface of the lower polarizer 12′, e.g., the surface of the PVA layer 12-1, may be treated to reduce glare and/or reflections. As such, the surface may be treated after forming the PVA layer 12-1 on the supporting layer 12-2.

In exemplary embodiments, the lower polarizer 12′ is coupled to an outer surface of the lower insulation substrate 110. The adhesive 12-4 is formed for this purpose.

Although not shown, a thin film transistor and a pixel electrode are formed on an inner surface of the lower insulation substrate 110. The thin film transistor and the pixel electrode may be formed in any suitable manner. To this end, an alignment layer (not illustrated) may be formed on the pixel electrode between the liquid crystal layer 3 and the lower insulation substrate 110.

The upper panel 200 will now be described in more detail.

According to exemplary embodiments, upper panel 200 may include an upper polarizer 12 and an upper insulation substrate 210. The upper polarizer 12 is disposed on the upper insulation substrate 210, such that the upper insulation substrate 210 is disposed between the upper polarizer 12 and the liquid crystal layer 3. The upper insulation substrate 210 may be made of (or include) any suitable material, such as, for example, transparent glass, plastic, etc.

The upper polarizer 12 may be configured similarly to the lower polarizer 12′, and thereby, may include a structure as illustrated in FIG. 2. In this manner, the upper polarizer 12 may be an absorptive polarizer.

According to exemplary embodiments, the upper polarizer 12 includes a PVA layer 12-1, a supporting layer 12-2, a compensation layer 12-3, and an adhesive 12-4. While specific reference will be made to this particular implementation, it is also contemplated that the upper polarizer 12 may embody many forms and include multiple and/or alternative components.

In exemplary embodiments, the adhesive 12-4 adheres the upper polarizer 12 to a first surface (e.g., an upper surface) of the upper insulation substrate 210. Any suitable material may be used as the adhesive 12-4, such that the adhesive 12-4 forms an optically clear adhesive film, a pressure sensitive adhesive (PSA), etc. The refractive index of the adhesive 12-4, according to exemplary embodiments, may be 1.48.

As seen in FIG. 1, the upper polarizer 12 is coupled to an upper surface of the upper insulation substrate 210. As such, the structure of upper polarizer 12 corresponds to that shown in FIG. 2. In other words, when coupled to the upper surface of the upper insulation substrate 110, the upper polarizer 12 includes a structure in which the layers 12-1, 12-2, 12-3, and 12-4 are disposed in the illustrated order on the upper insulation substrate 210.

With continued reference to FIG. 2, the compensation layer 12-3 is disposed on the adhesive 12-4. The compensation layer 12-3 includes discotic liquid crystal. According to exemplary embodiments, the refractive index of the compensation layer is 1.6. The compensation layer 12-3 may include a film that is rubbed to arrange the discotic liquid crystal. That is, the discotic liquid crystal may be disposed on the rubbed film, such that discotic liquid crystal molecules thereof are arranged in the rubbing direction near the rubbed film, and arranged in a different direction further away from the rubbed film. In this manner, the discotic liquid crystal may include a hybrid arrangement. Further, the discotic liquid crystal may be hardened to prevent the refractive index of the compensation layer 12-3 from changing. As such, the discotic liquid crystal may be disposed on the rubbed film in a hardened, hybrid-aligned state.

According to exemplary embodiments, the supporting layer 12-2 is disposed on the compensation layer 12-3. The supporting layer 12-2 includes a cyclic olefin polymer (COP). The COP is formed through a stretching process, such that the refractive index of the supporting layer 12-2 may be controlled by the stretching process in an x-axis direction or a y-axis direction. The refractive index of the supporting layer 12-2, according to exemplary embodiments, may be 1.52. To this end, it is noted that the supporting layer 12-2 may not include triacetate cellulose (TAC).

As seen in FIG. 2, the PVA layer 12-1 is disposed on the supporting layer 12-2. The PVA layer 12-1 is configured to transmit incident light in one linearly polarized direction. The refractive index of the PVA layer 12-1, according to exemplary embodiments, may be 1.5.

An outer surface of the upper polarizer 12, e.g., the surface of the PVA layer 12-1, may be treated to reduce glare and/or reflections. As such, the surface may be treated after forming the PVA layer 12-1 on the supporting layer.

In exemplary embodiments, the upper polarizer 12 is coupled to an outer surface of the upper insulation substrate 210. The adhesive 12-4 is formed for this purpose.

While not illustrated, a light blocking member, a color filter, and a common electrode may be formed on or in the upper insulation substrate 210. According to exemplary embodiments, the light blocking member or the color filter may be formed on or in the lower insulation substrate 110. To this end, an alignment layer (not shown) may be formed under the common electrode between the liquid crystal layer 3 and the upper insulation substrate 210.

As previously mentioned, the liquid crystal layer 3 is disposed between the upper panel 200 and the lower panel 100.

The liquid crystal layer 3 may include liquid crystal molecules having positive dielectric anisotropy. That is, long axes of the liquid crystal molecules may be parallel to the surfaces of the lower and upper panels 100 and 200 when an electric field is not applied to the liquid crystal layer 3. To this end, when an electric field is applied by, for instance, the pixel electrode and the common electrode, an alignment direction of the liquid crystal molecules may be changed to be in a perpendicular direction with respect to the lower and upper panels 100 and 200. The liquid crystal layer 3 may use a twisted nematic (TN) mode liquid crystal. Also, the liquid crystal layer 3 may be configured to cause a phase difference of between 400 nm and 480 nm.

While the lower polarizer 12′ and the upper polarizer 12 have been described as including a substantially similar configuration, it is contemplated that the lower polarizer 12′ and upper polarizer 12 may include different structures. To this end, it is also contemplated that even if the lower polarizer 12′ and the upper polarizer 12 include the same (or similar) structures, the refractive index of all or some of the corresponding layers may be different from each other.

According to exemplary embodiments, transmittance of the liquid crystal display may be improved via utilization of the lower polarizer 12′ and the upper polarizer 12. In this manner, the display quality of liquid crystal display may also be improved. Furthermore, it is contemplated that the supporting layer 12-2 of the lower polarizer 12′ and/or the upper polarizer 12 includes the COP with a variable refractive index, which varies, for instance, in a direction perpendicular to the lower and upper panels 100 and 200.

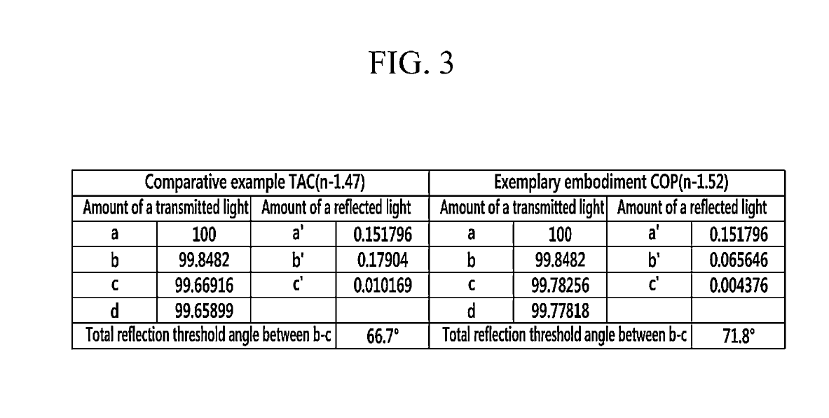

Characteristics of the polarizer 12 of FIG. 2 will be described in more detail with reference to FIGS. 3-6.

FIGS. 3-6 illustrate tabular or graphic characteristics of a COP used in a polarizer, according to exemplary embodiments.

FIG. 3 compares transmission, reflection, and threshold angle characteristics of a comparative polarizer using TAC as the supporting layer and an exemplary polarizer using a COP as the supporting layer.

Adverting momentarily to FIG. 2, transmission and reflection of light at or through each layer are indicated by arrows a, a′, b, b′, c, c′, and d. The amount of light being transmitted and reflected is provided in the table of FIG. 3. As seen in FIG. 2, the arrow “a” representing an amount of light passing through the adhesive 12-4 is an amount of the light is incident to an interface of the adhesive 12-4 and the compensation layer 12-3. In FIG. 3, the amount of this incident light is 100. The arrow “a′” represents the amount of light reflected at the interface of the adhesive 12-4 and the compensation layer 12-3. The arrow “b” represents the amount of light transmitted through the compensation layer 12-3 and is the amount of light incident to the interface of the compensation layer 12-3 and the supporting layer 12-2. The arrow “b′” represents the amount of light reflected at the interface of the compensation layer 12-3 and the supporting layer 12-2. The arrow “c” represents the amount of light transmitted through the supporting layer 12-2 and is the amount of light incident to the interface of the supporting layer 12-2 and the PVA layer 12-1. The arrow “c′” represents the amount of light reflected at the interface of the supporting layer 12-2 and the PVA layer 12-1. The arrow “d” represents the amount of the light transmitting through the PVA layer 12-1. In FIG. 3, a total internal reflection threshold angle between b-c is the total internal reflection threshold angle at the interface between the compensation layer 12-3 and the supporting layer 12-2.

It is noted that the comparative example uses TAC having a refractive index of 1.47 as the supporting layer 12-2. Referring to the comparative example, the transmission amount and the reflection amount of or at each layer is provided, and it may be confirmed that the total internal reflection threshold angle at the interface between the compensation layer 12-3 and the supporting layer 12-2 is 66.7 degrees.

Referring to the exemplary embodiment using the COP having a refractive index of 1.52 as the supporting layer 12-2, the transmission amount and the reflection amount in or at each layer is provided, and it may be confirmed that the total internal reflection threshold angle at the interface between the compensation layer 12-3 and the supporting layer 12-2 is 71.8 degrees.

Accordingly, it is readily apparent that the transmission amounts of the polarizer are higher in association with the exemplary embodiment, such that the transmittance is improved. Also, the total internal reflection threshold angle at the interface between the compensation layer 12-3 and the supporting layer 12-2 is larger in the exemplary embodiment, such that a possibility of total internal reflection is reduced. In this manner, the polarizer according to exemplary embodiments exhibits better transmissive and reflective qualities as compared to the comparative example with respect to display devices.

It is noted that the COP of the supporting layer affects the refractive index, such that the interface between the compensation layer 12-3 and the supporting layer 12-2 exhibits less reflection, and the transmission characteristic is improved. In FIG. 3, the amount of light (represented by the transmittance “c”) incident to the supporting layer 12-2 is 99.66916 in the comparative example, but is improved to 99.78256 in exemplary embodiments. As such, using the COP to affect the refractive index of the supporting layer 12-2 enables better transmittance. To further improve the transmittance, the refractive index of the discotic liquid crystal of the compensation layer 12-3 and the COP of the supporting layer 12-2 may be selected to cooperate with one another, as will become more apparent below.

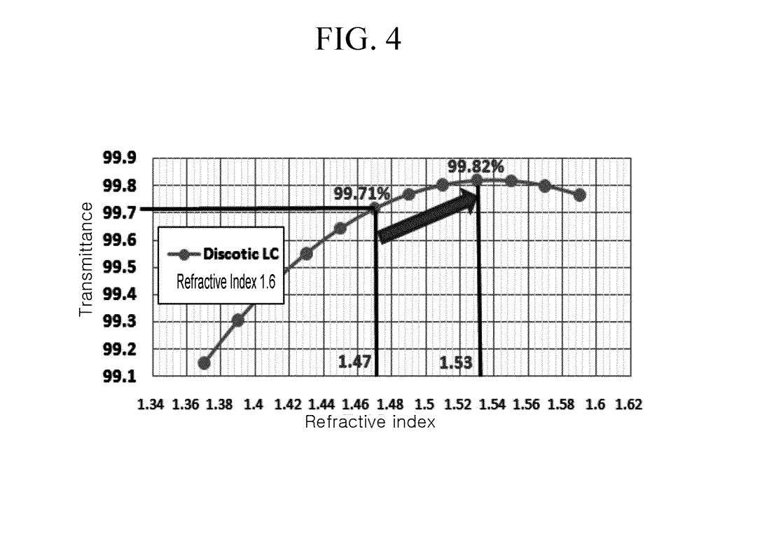

As seen in FIG. 4, the refractive index of the discotic liquid crystal of the compensation layer 12-3 may be 1.6. In this manner, it can be seen that the transmittance of the polarizer of FIG. 2 may be affected by varying the refractive index of the COP of the supporting layer 12-2.

For instance, if the refractive index of the COP is increased from 1.47 to 1.53, the transmittance may be improved by 0.11%. As seen in FIG. 4, maximum transmittance may be obtained when the refractive index of the COP is 1.53.

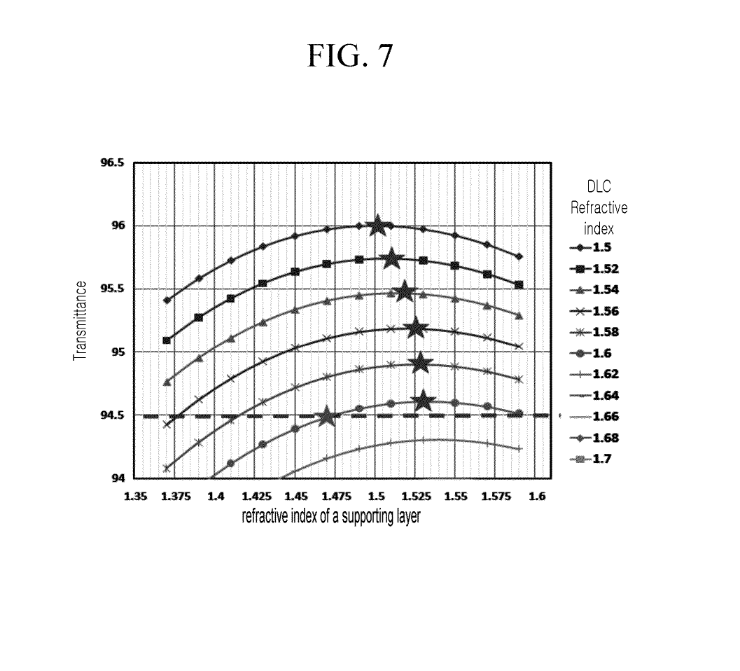

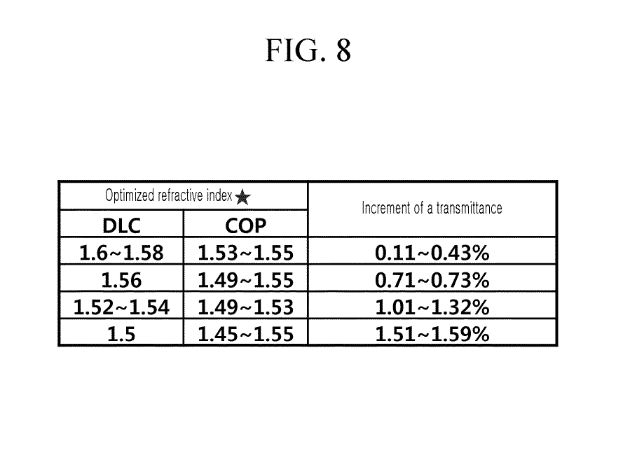

To this end, if the respective refractive indices of the supporting layer 12-2 and the compensation layer 12-3 of the polarizer are selected to cooperate with one another, maximum transmittance may be obtained and the transmission characteristic of a liquid crystal display including the polarizer may be improved. This will be described in more detail with reference to FIGS. 7 and 8.

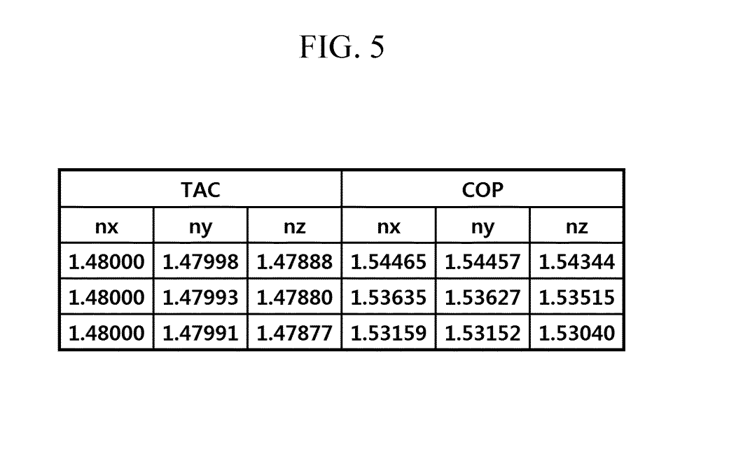

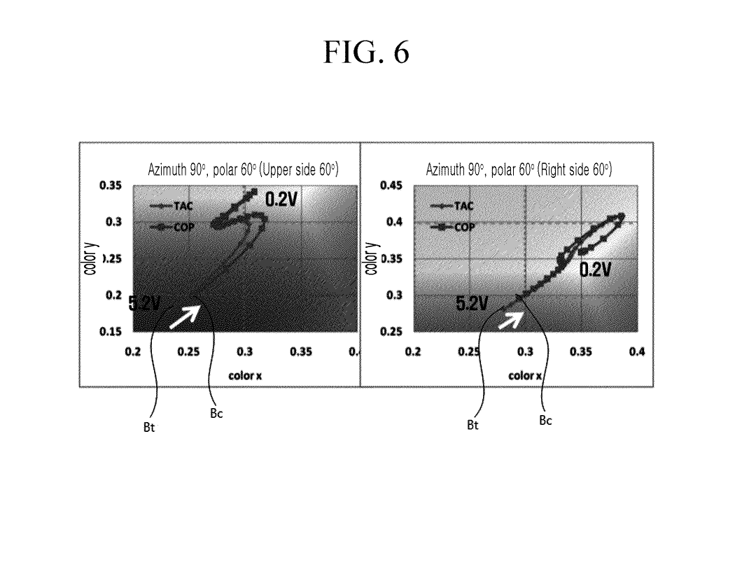

According to exemplary embodiments, the polarizer of FIG. 2 may also be utilized to reduce a color shift. This is shown in FIGS. 5 and 6.

FIG. 5 provides the refractive indices nx, ny, and nz for each wavelength band of the TAC of the comparative example and the COP of exemplary embodiments of the supporting layer 12-2.

As seen in FIG. 5, among the refractive indices nx, ny, and nz for each direction, the values of the first row are the refractive indices for light of 450 nm, the values of the second row are the refractive indices for light of 550 nm, and the values of the third row are the refractive indices for light of 650 nm.

It is noted that the TAC supporting layer 12-2 of the comparative example has a refractive index of 1.47. As seen in FIG. 5, the refractive index nx is not changed even though the wavelength of light is changed. In contrast, the COP supporting layer 12-2 according to exemplary embodiments has a refractive index of 1.52. As seen in FIG. 5, the refractive index is changed for each wavelength in each of nx, ny, and nz directions. Since the refractive indices change in all directions, black becoming bluish is less likely in association with the COP supporting layer 12-2 than with the TAC supporting layer 12-2. This is shown in FIG. 6.

FIG. 6 provides two graphs. The left graph shows a change of a color coordinate value at an upper side of 60 degrees, and the right graph shows a change of a color coordinate is value at a right side of 60 degrees. Also, in each graph, the comparative example using the TAC supporting layer 12-2 is associated with the line including diamonds, and the example using the COP supporting layer 12-2 according to exemplary embodiments is associated with the line including squares.

Accordingly, in a case of displaying black using a voltage of 5.2 V, which is shown in the left graph of FIG. 6, the black color is positioned at point Bt on the color coordinates of the comparative example, and the black color is positioned at point Bc on the color coordinates of the exemplary embodiment. In a case of displaying white using a voltage of 0.2 V, which is shown in the right graph of FIG. 6, the white color is displayed at a similar position in either case. This is because the change in the color coordinates is not large.

Accordingly, as can be seen in the moving path of the color coordinates, it may be confirmed that displaying black of the comparative example is bluer in each of the graphs of the upper side of 60 degrees and the right side of 60 degrees.

As such, it is apparent that using the COP supporting layer 12-2 improves the display quality of the black color.

The amount of light transmission of the polarizer of FIG. 2 will now be described over a range of refractive indices of the supporting layer 12-2 and the compensation layer 12-3.

FIGS. 7-9 compare refractive indices of a polarizer with transmission characteristics thereof, according to exemplary embodiments.

In FIG. 7, the transmittance of the polarizer of FIG. 2 is provided across various refractive indices of the discotic liquid crystal (DLC) of the compensation layer 12-3 and over a range of refractive indices of the COP of the supporting layer 12-2. A reference for determining the polarizer having transmittance of 94.5 is indicated by the horizontal dashed line. A polarizer is having higher transmittance than this may be used.

A position where the maximum transmittance for each refractive index of the discotic liquid crystal DLC is illustrated by a corresponding star in the respective plot lines. Accordingly, it is readily apparent that by selecting various refractive indices for the supporting layer 12-2 and the compensation layer 12-3 over others, maximum transmittance of the polarizers may be obtained.

The experimental results of FIG. 7 are summarized and represented in the table of FIG. 8. That is, the table of FIG. 8 provides ranges of refractive index values for each of the supporting layer 12-2 and the compensation layer 12-3 that are illustrated in the graph of FIG. 7. It is also noted that the refractive indices of the supporting layer 12-2 and the compensation layer 12-3 may be altered from those illustrated in FIGS. 7 and 8.

According to exemplary embodiments, the refractive index of the discotic liquid crystal used for the compensation layer 12-3 may have a value between 1.50 and 1.60, and the refractive index of the COP used for the supporting layer 12-2 may have a value between 1.49 and 1.55. To this end, it is noted that the discotic liquid crystal may itself exhibit a refractive index between 0.9677 and 1.0738.

As seen in FIG. 8, the refractive index of the COP may have a value of 1.45, such that exemplary embodiments may include refractive indices beyond those noted-above. To this end, however, when the refractive index of the COP is 1.45, the refractive index of the discotic liquid crystal may not be 1.6. As such, this combination is excluded in the table. However, if the refractive index of the discotic liquid crystal is controlled, although the COP having the refractive index of 1.45 is used, the transmittance may be greater.

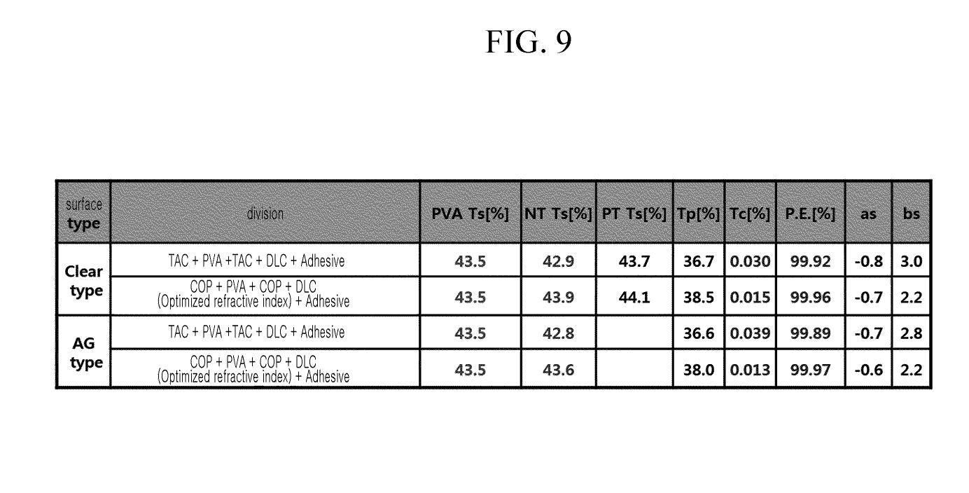

In FIG. 9, a transmission characteristic and polarization efficiency in various is comparative examples (using the TAC supporting layer 12-2) and various exemplary embodiments (using the COP supporting layer 12-2) are shown.

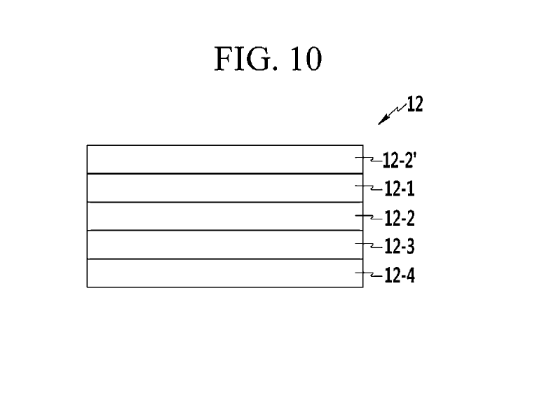

FIG. 9 is divided into examples in which the surface of the polarizers were configured to prevent glare (AG type), and examples in which the polarizers were not treated (Clear type). It is also noted that in each of the comparative examples and each of the exemplary embodiment examples, a supporting layer 12-2 was disposed on either side of the PVA layer 12-1 (e.g., above and below the PVA layer 12-2), which will be described in more detail in association with FIG. 10.

As can be seen in FIG. 9, in each case, when the transmittance Ts of the PVA layer 12-1 has the same value, the transmittance (NT Ts) for non-polarized light and the transmittance (PT Ts) for linear polarized light of the exemplary embodiment examples are larger than those of the comparative examples. To this end, the transmittance (Tp) for the light parallel to the transmissive axis in the exemplary embodiment examples is larger than that of the comparative examples. However, the transmittance (Tc) for the light perpendicular to the transmissive axis of the comparative examples is larger than that of the exemplary embodiment examples, such that with respect to transmittance Tc, the comparative examples transmit more light. Even still, the overall polarization efficiency (P.E.) of the exemplary embodiment examples is larger than that of the comparative examples.

Accordingly, if the COP is used as the supporting layer 12-2 and the refractive index is controlled, a polarizer with improved transmittance may be obtained and the polarization efficiency may also be improved. Further, as previously described, the color change effects are also reduced, and as such, the display quality may be improved.

Also, in FIG. 9, if an increment of the transmittance is changed, the transmittance is when the adhesive 12-4 is not used is increased by about 2.3%, and the transmittance when the adhesive 12-4 is used is increased by about 0.92%. However, this value is for one polarizer, and if two polarizers are used, the aforementioned transmittances may be respectively increased by 4.6% and 1.84%. Further, the polarizer, according to exemplary embodiments, may have a transmittance for non-polarized light of between 43% and 100%.

FIG. 10 is a cross-sectional view of a polarizer, according to exemplary embodiments.

The cross-sectional structure of FIG. 10 is similar to that illustrated in FIG. 2; however, the polarizer 12 illustrated in FIG. 10 further includes an outer supporting layer 12-2′ disposed on the PVA layer 12-1 and the supporting layer 12-2, such that the PVA layer 12-1 is disposed between the supporting layer 12-2 and the outer supporting layer 12-2′.

The outer supporting layer 12-2′ may be (or include) the COP, as previously described in association with the supporting layer 12-2, and as such, may have the same refractive index.

According to exemplary embodiments, the polarizer 12 includes the outer supporting layer 12-2′, the PVA layer 12-1, the supporting layer 12-2, the compensation layer 12-3, and the adhesive 12-4. While specific reference will be made to this particular implementation, it is also contemplated that the polarizer 12 may embody many forms and include multiple and/or alternative components.

The adhesive 12-4 couples the polarizer 12 to the outer surface of the upper or lower insulation substrate 110 and 210. Any suitable material may be used as the adhesive 12-4. As an example, the adhesive 12-4 may form an optically clear adhesive film, a pressure sensitive adhesive (PSA), etc. In exemplary embodiments, the refractive index of the adhesive is 1.48.

When the polarizer 12 of FIG. 10 is coupled to the outer surface of the upper insulation substrate 210, the structure of the polarizer 12 corresponds with the illustration. When the polarizer 12 of FIG. 10 is coupled to the outer surface of the lower insulation substrate 110, the structure of the polarizer 12 includes layers 12-2′, 12-1, 12-2, 12-3, and 12-4 in a reversed order.

According to exemplary embodiments, the compensation layer 12-3 is disposed on the adhesive 12-4. The compensation layer 12-3 includes discotic liquid crystal. In exemplary embodiments, the refractive index of the compensation layer is 1.6. The compensation layer 12-3 may include a film that is rubbed to arrange the discotic liquid crystal. That is, the discotic liquid crystal may be disposed on the rubbed film, such that discotic liquid crystal molecules thereof are arranged in the rubbing direction near the rubbed film, and are arranged in a different direction further away from the rubbed film. In this manner, the discotic liquid crystal may include a hybrid arrangement. Further, the discotic liquid crystal may be hardened to prevent the refractive index of the compensation layer 12-3 from changing. As such, the discotic liquid crystal may be disposed on the rubbed film in a hardened, hybrid-aligned state.

According to exemplary embodiments, the supporting layer 12-2 is disposed on the compensation layer 12-3. The supporting layer 12-2 includes a cyclic olefin polymer (COP). The COP is formed through a stretching process, such that the refractive index of the supporting layer 12-2 may be controlled by the stretching process of an x-axis direction or a y-axis direction. The refractive index of the supporting layer 12-2, according to exemplary embodiments, may be 1.52. To this end, it is noted that the supporting layer 12-2 may not include triacetate cellulose (TAC).

As seen in FIG. 10, the PVA layer 12-1 is disposed on the supporting layer 12-2. The PVA layer 12-1 is configured to transmit incident light in one linearly polarized direction. The refractive index of the PVA layer 12-1, according to exemplary embodiments, may be 1.5.

The outer supporting layer 12-2′ is disposed on the PVA layer 12-1. The outer supporting layer 12-2′ includes the COP. As previously mentioned, the COP is formed through a stretching process, such that the refractive index of the outer supporting layer 12-2′ may be controlled by the stretching process in an x-axis direction or a y-axis direction. The refractive index of the outer supporting layer 12-2′, according to exemplary embodiments, may be 1.52, like that of the supporting layer 12-2. The refractive index of the outer supporting layer 12-2′; however, may be different from the refractive index of the supporting layer 12-2. The outer supporting layer 12-2′, according to exemplary embodiments, may not include triacetate cellulose (TAC).

In exemplary embodiments, the outer surface of the outer supporting layer 12-2′ may be configured to reduce glare and/or reflections.

According to exemplary embodiments, a liquid crystal display may include a pair of polarizers 12 and 12′ coupled thereto, as seen in FIG. 1. In this manner, a polarizer having the same refractive index and the same layered structure may be disposed at either side of the liquid crystal layer 3, however, it is also contemplated that polarizers having different structures and/or different refractive indexes may be disposed at either side of the liquid crystal display. For instance, the polarizer of FIG. 10 and the polarizer of FIG. 2 may be included in the liquid crystal display.

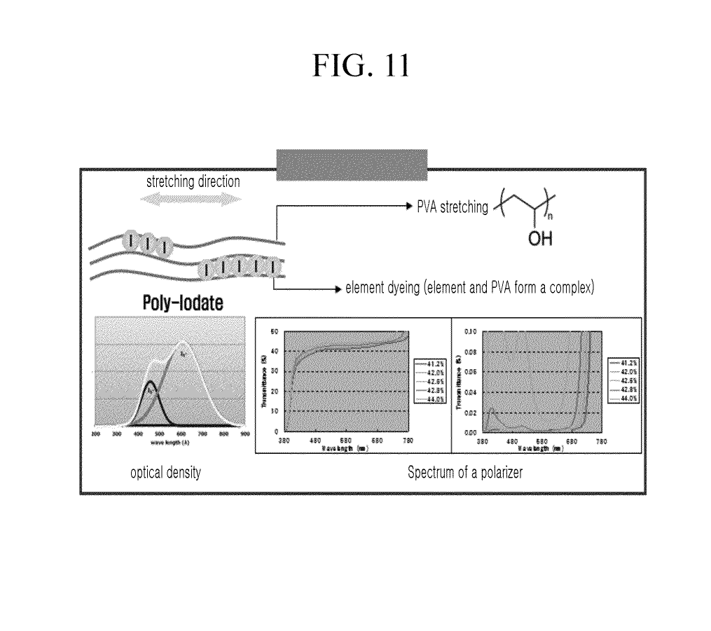

FIGS. 11-13 compare display characteristics of a display device with characteristics of a PVA polarizer layer in the display device, according to exemplary is embodiments.

It is noted that dying and absorbing iodine into the PVA layer 12-1 may be performed to increase transmittance of exemplary embodiments. As seen in FIG. 11, when dying and absorbing iodine in to the PVA layer 12-1, the transmittance is increased by the amounts shown in association with the I⁻, I³⁻, and I⁵⁻ structures, in which iodine atoms are connected to each other in increasing amounts.

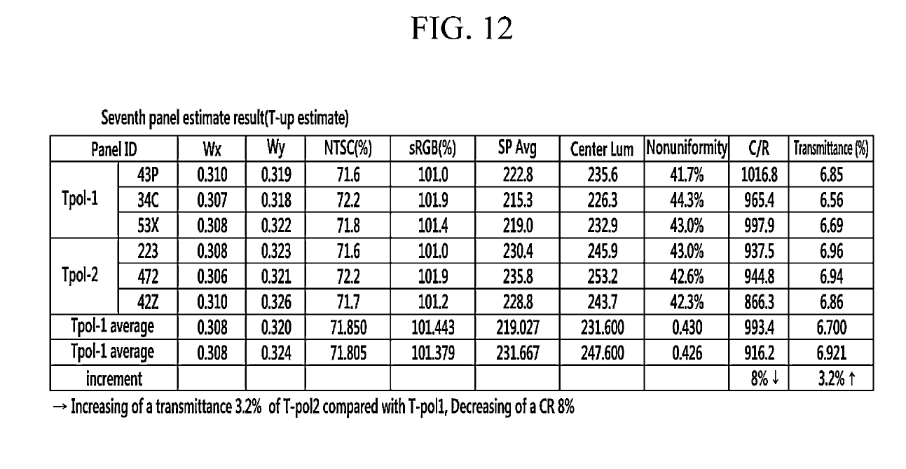

FIG. 12 is a table showing characteristics of exemplary polarizers dyed and absorbed with iodine, according to exemplary embodiments. Two exemplary polarizers Tpol-1 and Tpol-2 were tested. The Tpol-2 polarizer includes a larger amount of dyed and absorbed iodine than that of the Tpol-1 polarizer.

The polarizer Tpol-2 having the larger amount of the dyed and absorbed iodine has greater transmittance than the polarizer Tpol-1. It is noted, however, that the dyed and absorbed iodine may decrease a contrast ratio (C/R) of the polarizer.

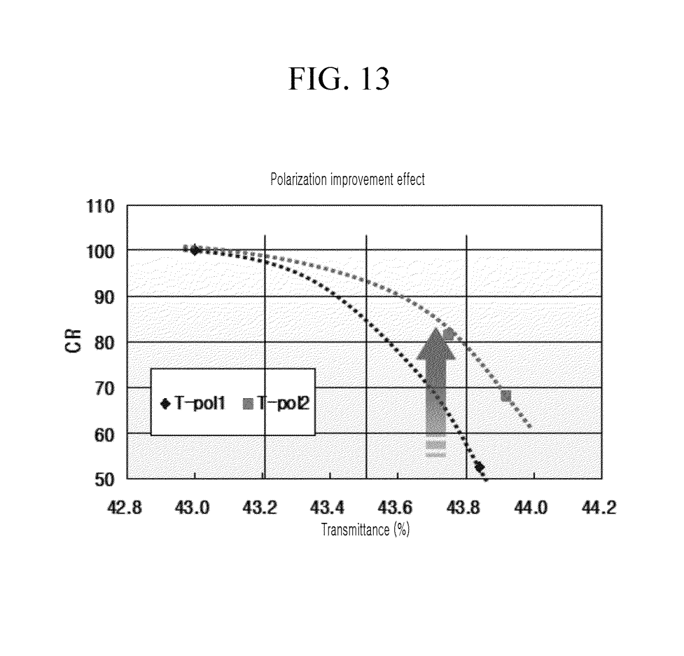

Referring to FIG. 12, the transmittance of the polarizer Tpol-2 is improved by 3.2% as compared with the polarizer Tpol-1, but the C/R is decreased by 8%. This effect is illustrated in the graph of FIG. 13.

As shown in FIGS. 11-13, the transmittance of exemplary polarizers may be increased by controlling the amount of iodine dyed and absorbed into the PVA layer 12-1. Since, however, the C/R of the exemplary polarizers may be decreased, a balance between increasing transmittance and decreasing C/R may be considered when forming the PVA layer 12-1.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A polarizer, comprising:
a polyvinyl alcohol (PVA) layer;
a supporting layer disposed on the PVA layer, the supporting layer comprising a cyclic olefin polymer (COP); and
a compensation layer disposed on the supporting layer, the compensation layer comprising discotic liquid crystal,
wherein the refractive index of the supporting layer is between 1.49 and 1.55, and
wherein the refractive index of the compensation layer is between 1.50 and 1.60.

2. The polarizer of claim 1, further comprising:
an adhesive disposed on the compensation layer.

3. The polarizer of claim 1, further comprising:
an additional supporting layer comprising the COP,
wherein the PVA layer is disposed between the supporting layer and the additional supporting layer.

4. The polarizer of claim 3, wherein the additional supporting layer is disposed on a surface of the PVA layer, the surface being configured to reduce at least one of glare and reflections.

5. The polarizer of claim 1, wherein:
the compensation layer further comprises a rubbed film; and
the discotic liquid crystal is disposed on the rubbed film in a hardened, hybrid-aligned state.

6. The polarizer of claim 1, wherein the refractive index of the discotic liquid crystal is between 0.9677 and 1.0738.

7. The polarizer of claim 6, wherein the transmittance of non-polarized light through the polarizer is between 43% and 100%.

8. A polarizer, comprising:
a polyvinyl alcohol (PVA) layer;
a supporting layer disposed on the PVA layer, the supporting layer comprising a cyclic olefin polymer (COP); and
a compensation layer disposed on the supporting layer, the compensation layer comprising discotic liquid crystal,
wherein the refractive index of the compensation layer is 1.5, between 1.52 and 1.54, 1.56, or between 1.58 and 1.6,
wherein, when the refractive index of the compensation layer is 1.5, the refractive index of the supporting layer is between 1.45 and 1.55,
wherein, when the refractive index of the compensation layer is between 1.52 and 1.54, the refractive index of the supporting layer is between 1.49 and 1.53,
wherein, when the refractive index of the compensation layer is 1.56, the refractive index of the supporting layer is between 1.49 and 1.55, and
wherein, when the refractive index of the compensation layer is between 1.58 and 1.6, the refractive index of the supporting layer is between 1.53 and 1.55.

9. The polarizer of claim 8, further comprising:
an adhesive disposed on the compensation layer.

10. The polarizer of claim 8, further comprising:
an additional supporting layer comprising the COP,
wherein the PVA layer is disposed between the supporting layer and the additional supporting layer.

11. The polarizer of claim 10, wherein the additional supporting layer is disposed on a surface of the PVA layer, the surface being configured to reduce at least one of glare and reflections.

12. The polarizer of claim 8, wherein:
the compensation layer further comprises a rubbed film; and
the discotic liquid crystal is disposed on the rubbed film in a hardened, hybrid-aligned state.

13. A liquid crystal display, comprising:
a first substrate;
a second substrate facing the first substrate;
a liquid crystal layer disposed between the first substrate and the second substrate;
a first polarizer disposed on the first substrate; and
a second polarizer disposed on the second substrate,
wherein the first substrate and the second substrate are disposed between the first polarizer and the second polarizer,
wherein at least one of the first polarizer and the second polarizer comprises:
a polyvinyl alcohol (PVA) layer,
a supporting layer disposed on the PVA layer, the supporting layer comprising a cyclic olefin polymer (COP), and
a compensation layer disposed on the supporting layer, the compensation layer comprising discotic liquid crystal,
wherein the refractive index of the supporting layer is between 1.49 and 1.55, and
wherein the refractive index of the compensation layer is between 1.50 and 1.60.

14. The liquid crystal display of claim 13, further comprising:
an adhesive disposed on the compensation layer.

15. The liquid crystal display of claim 13, further comprising:
an additional supporting layer comprising the COP,
wherein the PVA layer is disposed between the supporting layer and the additional supporting layer.

16. The liquid crystal display of claim 15, wherein the additional supporting layer is disposed on a surface of the PVA layer, the surface being configured to reduce at least one of glare and reflections.

17. The liquid crystal display of claim 13, wherein:
the compensation layer further comprises a rubbed film; and
the discotic liquid crystal is disposed on the rubbed film in a hardened, hybrid-aligned state.

18. The liquid crystal display of claim 13, wherein the liquid crystal layer comprises liquid crystal molecules having major axes aligned parallel to a surface of the first substrate or the second substrate when an electric field is not imposed on the liquid crystal layer and aligned perpendicular to the first substrate or the second substrate when the electric field is imposed on the liquid layer.

19. The liquid crystal display of claim 18, wherein the liquid crystal layer is configured to cause a phase difference of between 400 nm and 480 nm.

20. The polarizer of claim 1, wherein the supporting layer does not comprise triacetyl-cellulose.

21. The polarizer of claim 8, wherein the supporting layer does not comprise triacetyl-cellulose.

22. The liquid crystal display of claim 13, wherein the supporting layer does not comprise triacetyl-cellulose.

23. The polarizer of claim 1, wherein the PVA layer comprises iodine absorbed therein.

24. The polarizer of claim 8, wherein the PVA layer comprises iodine absorbed therein.

25. The liquid crystal display of claim 13, wherein the PVA layer comprises iodine absorbed therein.
